(19) United States
(12) Patent Application Publication
(10) Pub. No.: US 2025/0017151 A1
(43) Pub. Date: Jan. 16, 2025

(54) METHOD FOR CULTIVATING RICE ON CADMIUM-CONTAMINATED FARMLAND

(71) Applicants: INSTITUTE OF SOIL SCIENCE, CHINESE ACADEMY OF SCIENCES, Nanjing (CN); JIANGXI JIEDI ENVIRONMENTAL TREATMENT & ECOLOGICAL TECHNOLOGY CO., LTD, Yingtan (CN)

(72) Inventors: Jing Zhou, Nanjing (CN); Laiyong You, Nanjing (CN); Jiani Liang, Nanjing (CN); Kaidong CI, Nanjing (CN); Mengli Liu, Nanjing (CN); Leyong Kou, Nanjing (CN)

(73) Assignees: INSTITUTE OF SOIL SCIENCE, CHINESE ACADEMY OF SCIENCES, Nanjing, JS (CN); JIANGXI JIEDI ENVIRONMENTAL TREATMENT & ECOLOGICAL TECHNOLOGY CO., LTD, Yingtan, JX (CN)

(21) Appl. No.: 17/915,119

(22) PCT Filed: May 23, 2022
(86) PCT No.: PCT/CN2022/094334

§ 371 Date: Sep. 28, 2022

(30) Foreign Application Priority Data
Apr. 2, 2022 (CN) 202210351783.2

(51) Int. Cl. A01G 22/22; A01C 5/06; A01C 11/00; A01C 21/00; A01G 25/00

(52) U.S. Cl. CPC A01G 22/22; A01C 5/062; A01C 21/007; A01G 25/00; A01C 11/003

(57) ABSTRACT

The disclosure provides a method for cultivating rice on a Cd-contaminated farmland, belonging to the technical field of agricultural cultivation. The disclosure provides a method for cultivating rice with high-yield and low-Cd on a Cd-contaminated farmland, including applying organic and compound fertilizers to a Cd contaminated farmland, conducting soil preparation, mulching film and conducting punching, transplanting rice seedlings, and performing water management. The method may effectively avoid the activation of Cd caused by the drainage and drying of the paddy field, effectively improve the soil nutrient of the plough layer, increase the root density, the effective ear number and grain number per ear of the rice, and realize double effect of high-yield and low-Cd of the rice.

### CROSS REFERENCE TO RELATED APPLICATION

This patent application claims the benefit and priority of Chinese Patent Application No. 202210351783.2. entitled “Method for cultivating Rice on Cadmium-Contaminated Farmland” filed on Apr. 2, 2022, the disclosure of which is incorporated by reference herein in its entirety as part of the present application.

### TECHNICAL FIELD

The present disclosure relates to the field of agricultural cultivation technology, and particularly to a method for cultivating rice on cadmium contaminated farmland.

### BACKGROUND ART

Cadmium (Cd) has become the most major contaminant of arable soils, and Cd seriously threatens human health through rice food chain transmission. Related studies believe that the main exposure pathway of Cd for non-smoking people in China comes from rice intake, and therefore it has become one of the major issues to be solved to achieve the safe use of arable soils with mildly over Cd in the field of agroenvironments in China.

Continuous flooding is one of the important ways to reduce Cd in brown rice, but drainage and drying in the late reproductive stage frequently occur during the water management of rice production, most of which are on an anthropogenic basis. The drainage and drying in the paddy soil are also caused by high terrain and poor moisture and water conservation capacity thereof, or due to natural factors such as seasonal drought. Related studies have shown that more than 90% of Cd accumulation in brown rice mainly occurs at the late reproductive stage (from grain filling stage to maturation), in which the oxidative release of CdS caused by drainage makes a major contribution to Cd accumulation of rice in season. Therefore, it is of great importance to avoid Cd release during the late reproductive stage resulted from drainage to guarantee the safe use of Cd contaminated paddy fields.

Currently, there are many approaches to manage Cd contaminated rice, increasing soil pH, reducing the availability of soil Cd by heavy metal passivation/stabilizing materials and continuous flooding, and reducing Cd uptake and migration to rice grain by using low accumulating rice varieties, foliar control, and harvesting in advance, etc. The above approaches bear the problems of poor precision (critical reproductive stage), cumbersome operation, high cost, low acceptance by grower, and variable effects across regions/soil types, and most measures are at risk for rice yield reduction.

### SUMMARY

In view of the above, an objective of the present disclosure is to provide a method for cultivating rice on a Cd contaminated farmland, overcoming the deficiencies of current technologies that yield increase and Cd decrease cannot be achieved at the same time. The method addresses the technical difficulties of improving rice yield while decreasing Cd.

The present disclosure provides a method for cultivating rice on a Cd contaminated farmland, including the following steps:
applying organic and compound fertilizers to a Cd contaminated farmland, conducting soil preparation, mulching film and conducting punching, transplanting rice seedlings, and performing water management.

In some embodiments, the organic fertilizer is applied at 100 to 500 kg/mu.

In some embodiments, the compound fertilizer is applied at 100 to 200 kg/mu.

In some embodiments, a concentration of Cd in the Cd contaminated farmland is 0.3 to 1.5 mg/kg.

In some embodiments, the soil preparation includes rotary tilling, ditching and ridge forming, and surface flattening of the ridge.

In some embodiments, a depth of the rotary tilling is 20 to 25 cm.

In some embodiments, the ditching and ridge forming include making an orientation of a ditch consistent with that of a wind: a surface of the ridge has a width of 1.5 to 3 m, the ditch has a width of 20 to 40 cm, and the ditch has a depth of 15 to 20 cm.

In some embodiments, holes punched on the film are 5 to 10 cm in diameter, and the film is a black polyethylene film or a High Density Polyethylene (HDPE) film with a thickness greater than 8 decimillimeters.

In some embodiments, the rice seedlings have a row spacing of 20 to 30 cm, and a plant spacing of 10 to 20 cm, and a number of holes is 200,000 to 250.000/mu.

In some embodiments, the water management includes a shallow flooding at tillering and grain filling stages and a drainage 10 days before maturation.

The present disclosure provides a method for cultivating rice on a Cd contaminated farmland, including the following steps: applying organic and compound fertilizers to a Cd contaminated farmland, conducting soil preparation, mulching film and conducting punching, transplanting rice seedlings, and performing water management. Cultivation with organic fertilizer and film mulching results in a low redox potential, with the Eh at −80 mV to −220 MV, increases the relative abundance of sulfate reducing bacteria, reduces the oxidation process of free radicals in paddy fields due to light exposure, and avoids the oxidative release of CdS from rice fields due to drainage and drying caused by seasonal drought, thus decreasing the availability of Cd from plough layer soils at the grain filling and maturation stages of rice and reducing Cd uptake by rice; meanwhile, the film mulching reduces the soil gas exchange process, and avoids volatile nutrient loss, especially ammonia volatilization and greenhouse gas emission, and the lattice fixation of nutrient ions (potassium and ammonium ions) produced by repeated wet and dry alternations. The decrease of redox potential of the plough layer soil and the application of organic fertilizer also significantly increase the nutrient availability and enhance the root uptake capacity, especially the number of effective tiller (effective panicle) of rice, thereby achieving yield improvement. The method provided by the present disclosure may effectively solve the technical difficulties in rice where Cd reduction and yield increase are difficult to achieve simultaneously. The examples of the present disclosure demonstrate that the treatment of film mulching in combination with organic fertilizer application, as compared with the conventional management, not only significantly reduces the Cd concentration but also increases the yield of rice, with the Cd reduction rate ranging from 36% to 78%, and the yield increasing rate ranging from 8.5% to 30%. Safe production of all rice is achieved. Meanwhile, the method provided by the present disclosure also increases the relative abundance of sulfate reducing bacteria, increasing rapid acting nutrients in plough layer soils.

### BRIEF DESCRIPTION OF THE DRAWINGS

FIG. 1 is availability of Cd in plough layer soil at the grain filling stage;

FIG. 2 shows bacterial diversity in the plough layer soil at the grain filling stage.

### DETAILED DESCRIPTION OF THE EMBODIMENTS

The present disclosure provides a method for cultivating rice on a Cd contaminated farmland, including the following steps:
applying organic and compound fertilizers to a Cd contaminated farmland, conducting soil preparation, mulching film and conducting punching, transplanting rice seedlings, and performing water management.

In some embodiments, the method is applicable to mild/moderate Cd contaminated farmland. A concentration of Cd in mild/moderate Cd contaminated farmland is 0.3 to 1.5 mg/kg.

In some embodiments, the organic fertilizer is applied at 100 to 500 kg/mu, preferably at 150 to 450 kg/mu, more preferably at 200 to 400 kg/mu, and even more preferably at 300 kg/mu. In some embodiments, the organic fertilizer includes one or more of a crop straw; a green fertilizer and a barnyard manure. In some embodiments, the crop straw is rice straw. The crop straw is crushed and spread on the farmland. In some embodiments, the compound fertilizer is applied at 100 to 200 kg/mu, preferably at 150 kg/mu. In some embodiments, the compound fertilizer includes nitrogen, phosphorus, and potassium at a mass ratio of 15:8:8. Application of the organic and compound fertilizers, on the one hand, increases the soil nutrients in the plough layer and guarantees sufficient nutrient supply during the reproductive stage of rice, which in turn improves the rice yield; on the other hand, it increases total reducing substances in the soil, obviously reduces soil redox potential in combination with film mulching, thus promoting the transition of free ionic state to precipitate state and reducing the activity of Cd.

In some embodiments, the soil preparation includes rotary tilling, ditching and ridge forming, and surface flattening of the ridge. In some embodiments, a depth of the rotary tilling is 20 to 25 cm, preferably 22 to 23 cm. The rotary tilling is conductive to mixing fertilizer with the soil well and better playing the role of organic fertilizer. In some embodiments, the ditching and ridge forming include making an orientation of a ditch consistent with that of a wind, which allows for ventilation and light transmission, reduces pest and disease occurrence, and favors rice yield increase; in some embodiments, a surface of the ridge has a width of 1.5 to 3 m, preferably 1.8 to 2.5 m. The ditch has a width of 20 to 40 cm, preferably 25 to 35 cm, and even more preferably 30 cm. In some embodiments, the ditch has a depth of 15 to 20 cm, more preferably 18 cm.

In some embodiments, holes punched on the film are 5 to 10 cm, preferably 8 cm in diameter. The film is a black polyethylene film or a High Density Polyethylene (HDPE) film with a thickness greater than 8 decimillimeters. In some embodiments, spacing of the holes is consistent with that of rows between planted rice. The film mulching can avoid the generation of free radicals in the soil surface due to light to oxidize CdS in the soil, thereby reducing the activity of Cd in the plough layer soil and weed emergence, increasing temperature of the plough layer, and improving the activity of roots.

In some embodiments, the rice seedlings have a row spacing of 20 to 30 cm and a plant spacing of 10 to 20 cm, and a number of holes is 200,000 to 250,000/mu. The row spacing of the rice seedlings is preferably 20-30 cm, more preferably 25 cm. The plant spacing is preferably 10 to 20 cm, more preferably 15 cm. In some embodiments, a number of holes is 200,000 to 250,000/mu, preferably 220,000 to 230,000/mu., which guarantees planting density and increases rice yield.

In some embodiments, the water management includes a shallow flooding at tillering and grain filling stages and a drainage 10 days before the maturation. In some embodiments, the shallow flooding has a height of 2 to 5 cm, preferably 3 to 4 cm. In some embodiments, a drainage during the grain filling stage is 20 days before the rice is harvested. In middle and later stages of the drainage of the water management, the main purpose of the drainage is to increase an oxygen concentration in the soil, to avoid a decrease in the availability of trace elements caused by continuous flooding, which is beneficial to increase the yield and harvest, and may also highlight the effect of film mulching.

In some embodiments, the method is suitable for acidic soil in southern China, preferably for paddy soil with yellow-brown loam, paddy soil developed with red clay in the fourth season, and paddy soil developed by gray alluvium in the Xinjiang River Basin, more preferably for paddy soil with yellow-brown loam.

In order to further illustrate the present disclosure, the method for cultivating rice on a cadmium-contaminated farmland provided by the present disclosure will be described in detail below with reference to the examples, but they should not be construed as limiting the protection scope of the present disclosure.

### Example 1

A plot experiment of one-season mid-season rice was carried out on a paddy soil with yellow-brown loam (Huanggang. Hubei) with a soil pH of 5.65±0.15 and a total Cd of 1.2±0.05 mg/kg in 2021. The rice varieties were Fengliang Youxiang I (common rice) and Y Liangyou 900 (super rice). Groups of conventional management (no film mulching+no straw), and film+straw mulching were set for planting, where the straw was applied at 150 kg/mu (dry weight) rice straw, the film was black HDPE film with a thickness of 8 decimillimeters, water management adopted flooding at early stage, and the rice was drained 20 days before the rice was mature and harvested. The test results are shown in Table 1.

TABLE 1
Results of test plot with yellow-brown soil in Qichun, Hubei

| | Variety | | | |
|---|---|---|---|---|
| | Fengliangyouxiang I | | Y Liangyou 900 | |
| | Brown rice | Yield | Brown rice | |
| Treatment | Cd (mg/kg) | (kg/mu) | (Cd) (mg/kg) | Yield(kg/mu) |
| Conventional | 0.48 ± 0.05a | 553 ± 29b | 0.56 ± 0.06a | 652 ± 33b |
| management | | | | |
| (Control) | | | | |
| Film + straw | 0.12 ± 0.02b | 608 ± 19a | 0.15 ± 0.04b | 708 ± 24a |

Note:
different lowercase letters indicate significant differences between groups, p < 0.05.

It could be seen from Table 1 that the straw and film mulching treatment significantly reduced the Cd concentration and increased the rice yield.

### Example 2

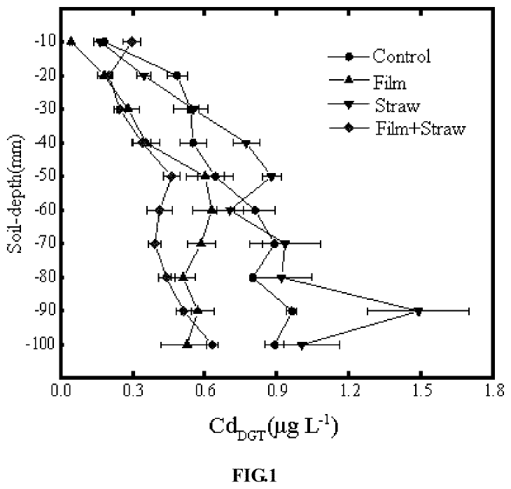

A plot experiment of one-season late rice was carried out on a paddy soil (Jiujiang, Jiangxi) developed with red clay in the fourth season with a soil pH of 5.82 and a total Cd of 0.85 mg/kg in 2021. The rice variety was Tianyouhuazhan. Groups of conventional management (Control), film and straw mulching (Film+Straw), single mulching (Film), and single straw (Straw) were set, in which the straw was rape straw and applied at 200 kg/mu, the film made of black HDPE film with a thickness of 6 decimillimeters was mulched, water management was conducted according to local conventional management, and high-resolution DGT device was used to characterize the bioavailability of Cd in plough layer soil during rice grain filling stage. Particularly, a high-resolution DGT (Chelex-100, Zhisensor Environment http://www.easysensor.net/) was subjected to nitrogen blowing and deoxidizing treatment indoors before use, then placed in the plough layer soil (0-10 cm) of each plot. After equilibration for 24 hours, the DGT device was taken out and a DGT adsorption film was cut to 1 cm/segment with a ceramic blade and eluted with 1mol/L HNO₃, and the Cd concentration in a resulting eluate was determined by ICP-Ms. The results are shown in FIG. 1.

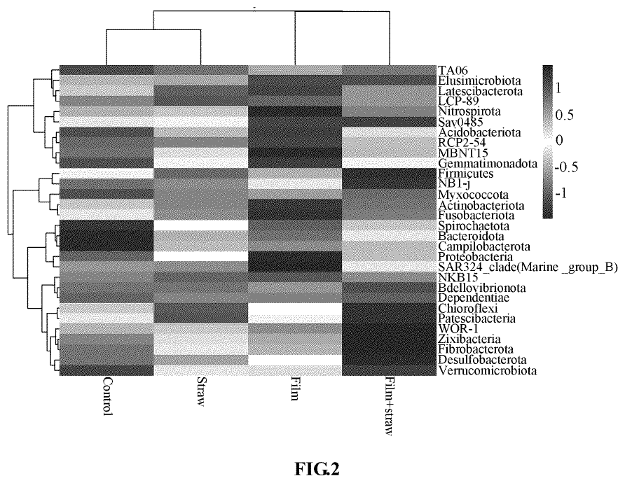

Fresh samples of plough layer soil (0-15 cm) were collected during the grain filling stage of rice, frozen in liquid nitrogen, then stored on drikold for transportation, and sent to Shanghai OeBiotech Co. Ltd. for extraction of soil DNA. 16S amplicon sequencing was performed to analyze microbial diversity (the results are shown in FIG. 2). The quick-acting N, P, K nutrients in the soil were analyzed by conventional methods, and samples were collected at the mature stage of rice to determine the yield and Cd content in brown rice. The test results are shown in Table 2.

TABLE 2
Results of the test plot with red soil in Jiujiang, Jiangxi

| | | | | Available | Fast-acting |
|---|---|---|---|---|---|
| | Yield | Cd in brown | Soil NH₄—N | phosphorus | potassium |
| Treatment | (kg/mu) | rice (mg/kg) | (mg/kg) | (mg/kg) | (mg/kg) |
| Conventional | 568 ± 48a | 0.35 ± 0.08b | 32 ± 3.8b | 12.8 ± 1.2b | 87 ± 7b |
| management | | | | | |
| Film | 673 ± 53ab | 0.18 ± 0.02ab | 45 ± 5.5a | 13.2 ± 2.2ab | 94 ± 6ab |
| Straw | 691 ± 38b | 0.24 ± 0.06b | 22 ± 3.2c | 13.8 ± 2.1ab | 112 ± 4a |
| Film + Straw | 724 ± 83c | 0.15 ± 0.01a | 38 ± 3.4b | 15.6 ± 1.2a | 115 ± 6 a |

Note:
different lowercase letters indicate significant differences between groups, p < 0.05.

It could be seen from FIGS. 1 to 2 and Table 2 that the Film and Straw treatment significantly reduced the concentration of CdDGT in the plough layer soil, increased the relative abundance of sulfate-reducing bacteria and the available nutrients in the plough layer soil, significantly improved the rice yield, and reduced the Cd content of brown rice, with a Cd reduction rate of 57% and a yield increasing rate of 30%. Safe production of rice was achieved.

### Example 3

A plot verification experiment of one-season late rice was carried out on a paddy soil (Yingtan, Jiangxi) developed by grey alluvium in the Xinjiang River Basin with a pH value of 6.05 and a total Cd of 1.08 mg/kg. The variety was Wuyouhuazhan. Groups of conventional management, straw+film, film, and straw were set, in which the straw was rape straw and applied at 200 kg/mu, the film made of black HDPE film with a thickness of 6 decimillimeters was mulched, and water management was conducted according to local conventional management. The results are shown in Table 3.

TABLE 3
Results of plots with river alluvial soil in Yingtan, Jiangxi.

| Treatment | Yield (kg/mu) | Brown rice Cd (mg/kg) |
|---|---|---|
| Conventional management | 614 ± 34b | 0.25 ± 0.03b |
| (control) | | |
| Film | 582 ± 29a | 0.12 ± 0.02a |
| Straw | 602 ± 39b | 0.27 ± 0.06b |
| Straw + Film | 746 ± 10c | 0.16 ± 0.03a |

Note:
different lowercase letters indicate significant differences between groups, p < 0.05.

It could be seen from Table 3 that the straw and film treatment significantly increased the rice yield and decreased Cd, with a Cd reduction rate of 36%, and a yield increasing rate of 21.4%. Safe production of all rice was achieved.

The method of cultivation provided by the present disclosure may simultaneously increase the yield and reduce Cd in rice effectively, and is not affected by the region (soil type)/rice variety. Especially for the farmlands with poor moisture and water storage capacity due to seasonal drought or high terrain, it may effectively avoid the release of Cd caused by the drainage and drying of the paddy field, effectively improve the soil nutrients in the plough layer soil, increase the root density, and increase the effective ear number and grain number per ear of rice, thereby increasing crop yield.

The descriptions of the above examples are only used to help understand the method and the core idea of the present disclosure. It should be pointed out that for those skilled in the art, without departing from the principle of the present disclosure, several improvements and modifications can also be made to the present disclosure, and these improvements and modifications also fall within the claimed protection scope of the present disclosure. Various modifications to these embodiments will be readily apparent to those skilled in the art, and the generic principles defined herein may be implemented in other embodiments without departing from the spirit or scope of the disclosure. Thus, the present disclosure is not intended to be limited to the embodiments shown herein, but is to be accorded the widest scope consistent with the principles and novel features disclosed herein.

What is claimed is:

1. A method for cultivating rice on a Cadmium (Cd)-contaminated farmland, comprising,
applying organic and compound fertilizers to a Cd contaminated farmland, conducting soil preparation, mulching film and conducting punching, transplanting rice seedlings, and performing water management.

2. The method for cultivating rice according to claim 1, wherein the organic fertilizer is applied at 100 to 500 kg/mu.

3. The method for cultivating rice according to claim 1, wherein the compound fertilizer is applied at 100 to 200 kg/mu.

4. The method for cultivating rice according to claim 1, wherein a concentration of Cd in the Cd contaminated farmland is 0.3 to 1.5 mg/kg.

5. The method for cultivating rice according to claim 1, wherein the soil preparation comprises rotary tilling, ditching and ridge forming, and surface flattening of the ridge.

6. The method for cultivating rice according to claim 5, wherein a depth of the rotary tilling is 20 to 25 cm.

7. The method for cultivating rice according to claim 5, wherein the ditching and ridge forming comprise making an orientation of a ditch consistent with that of a wind; a surface of the ridge has a width of 1.5 to 3 m, the ditch has a width of 20 to 40 cm, and the ditch has a depth of 15 to 20 cm.

8. The method for cultivating rice according to claim 1, wherein holes punched on the film are 5 to 10 cm in diameter, and the film is a black polyethylene film or a High Density Polyethylene (HDPE) film with a thickness greater than 8 decimillimeters.

9. The method for cultivating rice according to claim 1, wherein the rice seedlings have a row spacing of 20 to 30 cm, and a plant spacing of 10 to 20 cm, and a number of holes is 200,000 to 250,000/mu.

10. The method for cultivating rice according to claim 1, wherein the water management comprises a shallow flooding at tillering and grain filling stages and a drainage 10 days before maturation.

11. The method for cultivating rice according to claim 10, wherein the organic fertilizer is applied at 100 to 500 kg/mu.

12. The method for cultivating rice according to claim 10, wherein the compound fertilizer is applied at 100 to 200 kg/mu.

13. The method for cultivating rice according to claim 10, wherein a concentration of Cd in the Cd contaminated farmland is 0.3 to 1.5 mg/kg.

14. The method for cultivating rice according to claim 10, wherein the soil preparation comprises rotary tilling, ditching and ridge forming, and surface flattening of the ridge.

15. The method for cultivating rice according to claim 10, wherein a depth of the rotary tilling is 20 to 25 cm.

16. The method for cultivating rice according to claim 10, wherein the ditching and ridge forming comprise making an orientation of a ditch consistent with that of a wind; a surface of the ridge has a width of 1.5 to 3 m, the ditch has a width of 20 to 40 cm, and the ditch has a depth of 15 to 20 cm.

17. The method for cultivating rice according to claim 10, wherein holes punched on the film are 5 to 10 cm in diameter, and the film is a black polyethylene film or a HDPE film with a thickness greater than 8 decimillimeters.

18. The method for cultivating rice according to claim 10, wherein the rice seedlings have a row spacing of 20 to 30 cm, and a plant spacing of 10 to 20 cm, and a number of holes is 200,000 to 250,000/mu.
